(19) United States
(12) Patent Application Publication
(10) Pub. No.: US 2007/0208435 A1
(43) Pub. Date: Sep. 6, 2007

(54) Assembly for an automation system

(75) Inventor: Thomas Schott, Hausen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT

(21) Appl. No.: 11/707,198

(22) Filed: Feb. 13, 2007

(30) Foreign Application Priority Data
Mar. 6, 2006 (EP) 06004537.4

(51) Int. Cl. G05B 11/01; G08B 21/00

(52) U.S. Cl. 700/17; 340/679

(57) ABSTRACT

There is described an assembly, having at least one input/output and having means for storing a program and a method for project planning a program for an assembly of an automation system, with an absolute address being assigned to each of the inputs/outputs and a unique identifier being assigned to each absolute address when the program is created. An electronic display means is provided to improve the control and monitoring of an assembly of this type, to display the assigned identifiers as plain text and/or symbols.

### CROSS REFERENCE TO RELATED APPLICATIONS

This application claims priority of European application No. 06004537.4 EP filed Mar. 6, 2006, which is incorporated by reference herein in its entirety.

### FIELD OF INVENTION

The invention relates to an assembly having at least one input/output for an automation system and/or a method for project planning a program for an assembly of an automation system.

### BACKGROUND OF INVENTION

Each input/output of an assembly in an automation system has a predetermined absolute address, which specifies a precise, numerical position in a main memory. Each input/output occupies an I/O address (I/O: input/output), the absolute address of which can be determined by means of a base address. Accordingly, the absolute address mentioned in this application also corresponds to the physical address. An absolute address can be replaced by intelligible symbolic names, e.g. for the input E0.1 the symbol key 1. Absolute and/or symbolic addresses are always used for unique identification between a programmable logic control and the assembly addresses when writing the programmable logic control program. It is thus possible to understand in a quick and simple manner which absolute or symbolic addresses are assigned to a physical input/output.

Furthermore, a selected assembly with user-specific information (e.g. name, bus address, system characteristics or location characteristics) is to be visible to the user from the outside without additional means. This often occurs nowadays by means of label panels. These label panels must be written here by the user using special software and hardware (e.g. printer) or by hand.

LEDs (Light Emitting Diodes) are frequently used to represent the statuses of inputs/outputs. In this way, the users are informed about a specific status of the assembly by means of labels, colors and the blinking frequency of the LEDs.

### SUMMARY OF INVENTION

An object underlying the invention is to improve the HMI (Human Machine Interface) of an assembly for an automation system, with the assembly featuring at least one input/output.

The object is achieved by an assembly for an automation system having means for storing a program for controlling the assembly and at least one input/output, with an absolute/physical address being assigned to each of the inputs/outputs and a unique identifier being assigned to each absolute address when the program is planned into the project, with an electronic display means being provided, in order to display the assigned identifiers as plain text and/or symbols.

In addition, this object is achieved by a method for project planning a program for an assembly of an automation system, in which the assembly comprises at least one input/output, with an absolute/physical address being assigned to each of the inputs/outputs and a unique identifier being assigned to each absolute address when the program is planned into the project, with the assigned identifiers being displayed by means of electronic display means as plain text and/or symbols.

A further object underlying the invention is to display information about an input/output of an assembly by means of a novel display technology, in particular OLED (Organic Light-Emitting Diode). In such cases this type of assembly comprises means for storing a program for controlling this assembly and at least one input/output, with an absolute address being assigned to each of the inputs/outputs and a unique identifier (e.g. name, bus address, system identifier or location identifier) being assigned to each absolute address when the program is created. In this assembly, an electronic display means is provided to display the assigned identifiers as plain text and/or symbols. When a project (e.g. program, hardware and networking information) is downloaded which serves to use this assembly in an automation system, the absolute/symbolic identifier is also loaded into the assembly. This enables the absolute/symbolic identifiers defined in the project to be displayed according to the positions of the inputs/outputs directly after downloading. In other words, the plain text and symbols can contain the absolute and/or symbolic addresses in each instance for each of the inputs/outputs. The assembly according to the invention no longer requires a label and as a consequence thereof no extra printer or hand-written sticker, and the time taken to project plan and commission an assembly as well as the turnaround time after changes to the project planning can be reduced.

The information relating to the current status of the assembly is advantageously shown in conjunction with an absolute address as plain text and/or symbols. This information can be shown at the same time as the absolute address by means of the display means, with an input/output being assigned to this absolute address, by means of which input/output a control is implemented and the assembly is thus brought into the required status. User-specific information is thus presented to the user. This enables the statuses of the assembly and/or the inputs/outputs to be uniquely displayed and/or recognized. This makes a unique relationship and/or easily intelligible interface (e.g. HMI interface) possible between users and the assembly and/or system. It also enables the maintenance and/or repair of the assembly to be implemented in a simpler manner. The parameters of the assembly can be set or changed without a computer and technical software.

According to an advantageous embodiment of the invention, the display means (display) is arranged on the front side of the inputs/outputs, e.g. the front covers of the inputs/outputs can be equipped with a display, with the display also covering a surface as large as the front covers. To this end, the identifiers displayed on the display also display the arrangement or the sequence of the inputs/outputs accordingly. In this way, the absolute address and/or user-specific information can be displayed one-to-one according to the arrangement of the inputs/outputs, in a manner visible from the outside.

According to a further advantageous embodiment of the invention, the display means is designed as a touch screen. Since a touch screen offers outstanding attributes in the sense of HMI (Human Machine Interface), a display of this type allows the outputs and inputs of information to be displayed simultaneously without any effort, i.e. actions can be performed directly on displayed objects. The costs and space for keys for instance can thus be saved.

Organic light-emitting diodes, also known as OLEDs, can also be used as display means for instance. A modern OLED display can be as thin as a film and can thereby exhibit a correspondingly high mobility and/or flexibility. It requires considerably less energy compared with the liquid crystal display or LED displays, makes backlighting unnecessary and exhibits a large visual angle (up to 170°) and a high switching speed.

### BRIEF DESCRIPTION OF THE DRAWINGS

The invention is described in more detail below within the framework of the exemplary embodiments, with reference to the figures, in which;

FIG. 1: shows an assembly having LEDs as status displays

FIG. 2: shows an assembly according to the invention having OLED displays

### DETAILED DESCRIPTION OF INVENTION

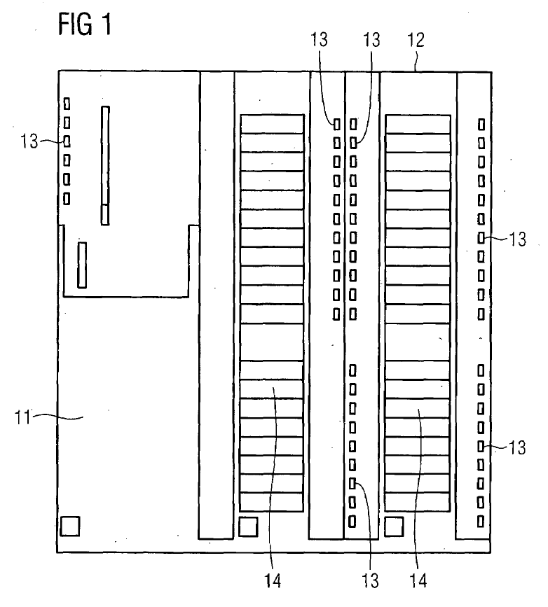

The conventional assembly 11 shown in FIG. 1 comprises an arrangement of inputs/outputs 12 and an LED display 13, with an absolute address being assigned to each of the inputs/outputs 12. The absolute addresses are replaced by intelligible symbolic names and characterized in each instance by a label panel 14 at the corresponding positions of the inputs/outputs 12. Writing information into these label panels 14 is a long-winded process involving special software and hardware (e.g. printers) or handwritten entries.

Statuses are represented for this assembly 11 with the aid of LEDs 13, with an individual LED 13 being provided for each input/output 12 to represent a current status of the input/output 12 by illumination (blink) or by the color of the LED 13. In addition, it is impossible for this assembly 11 to present a dynamic item of information relating to the statuses of the assembly 11 in conjunction with a current status of an input/output 12.

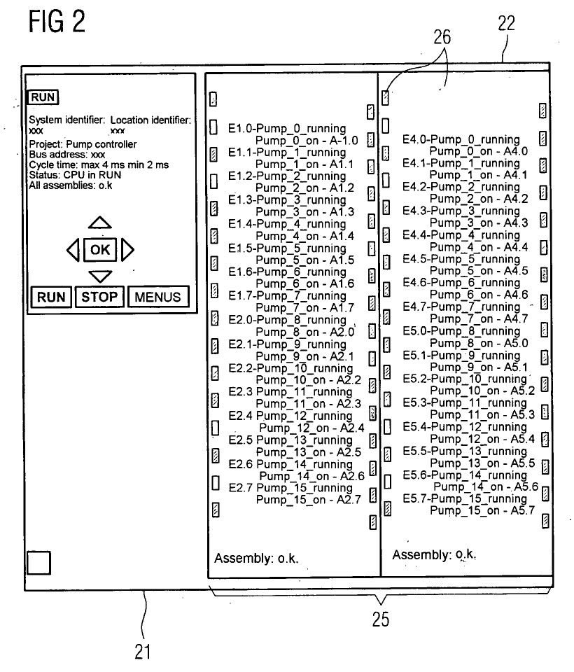

FIG. 2 shows an inventive assembly 21, likewise having a plurality of inputs/outputs 22. A program for controlling the assembly 21 is stored in this assembly 21, with a unique identifier (e.g. name, bus address, system identifier or location identifier) being assigned to each absolute address when the program is planned into the project.

This assembly 21 comprises an OLED display 25, in order to display the assigned identifiers as plain text and/or symbols 26. The so-called plain text and the symbols 26 contain the absolute address and/or symbolic address in each instance for each of the inputs/outputs 22. The planned identifiers can likewise be automatically displayed by means of the OLED displays; in this way information relating to the current statuses of the assembly 21 in conjunction with the absolute addresses is displayed as plain text and/or symbols 26, i.e. the statuses of the assembly 21 can be uniquely displayed and recognized as a result of control by the input/outputs 22. Symbolic information relating to the assembly, the inputs/outputs or function keys etc. can also be displayed on the OLED displays for instance, in this way, a unique relationship and/or an intelligible interface (e.g. HMI) are enabled, and the assembly 21 can be maintained and repaired in a simple manner.

1.-7. (canceled)

8. An assembly for an automation system, comprising
a memory to store a program for controlling the assembly,
an input having an absolute address assigned to the input;
an output having an absolute address assigned to the output;
a unique identifier assigned to the absolute address of the input or assigned to the absolute address of the output;
an electronic display to display the identifiers.

9. The assembly as claimed in claim 8, wherein the assigned identifiers are displayed as plain text.

10. The assembly as claimed in claim 8, wherein the identifiers is displayed as plain text and as a symbol.

11. The assembly as claimed in claim 9, wherein the electronic display is arranged on a front side of the assembly according to the input and output of the assembly.

12. The assembly as claimed in claim 10, wherein the electronic display is arranged on a front side of the assembly according to the input and output of the assembly.

13. The assembly as claimed in claim 11, wherein the electronic display is a touch screen.

14. The assembly as claimed in claim 11, wherein the electronic display comprises organic light-emitting diodes.

15. The assembly as claimed in claim 11, wherein the electronic display shows the status of the input and output of the assembly.

16. The assembly as claimed in claim 15, wherein the electronic display shows a absolute address of the input and output.

17. The assembly as claimed in claim 16, wherein the electronic displays shows the input and output according to an arrangement of a plurality of inputs and outputs at the assembly.

17. The assembly as claimed in claim 17, wherein the electronic display covers a surface as large as the front side of the assembly.

18. A method for creating a program for an assembly of an automation system, comprising:
providing the assembly that comprises at least one connector used as an input or an output;
assigning an absolute address to the connector; and
assigning a unique identifier to the absolute to display the assigned identifiers as plain text at a display of the assembly.

19. A method for creating a program for an assembly of an automation system, comprising:
providing the assembly that comprises at least one connector used as an input or an output;
assigning an absolute address to the connector; and
assigning a unique identifier to the absolute to display the assigned identifiers as a symbol at a display of the assembly.

20. The method as claimed in claim 18, wherein information related to a current status of the assembly is displayed as plain text on the display.

21. The method as claimed in claim 18 wherein information related to a current status of the assembly is displayed as a symbol on the display.

22. The method as claimed in claim 19 wherein information related to a current status of the assembly is displayed as a symbol on the display.
